(19) United States
(12) Patent Application Publication
(10) Pub. No.: US 2025/0360417 A1
(43) Pub. Date: Nov. 27, 2025

(54) SYSTEM AND METHODS FOR ELECTRONIC GAMING CONTROL AND FRAGMENTED FUNCTIONALITY NORMALIZATION USING ARTIFICIAL INTELLIGENCE

(71) Applicant: Sony Interactive Entertainment LLC, San Mateo, CA (US)

(72) Inventors: Charles McCoy, San Diego, CA (US); True Xiong, San Diego, CA (US)

(73) Assignee: Sony Interactive Entertainment LLC, San Mateo, CA (US)

(21) Appl. No.: 18/672,585

(22) Filed: May 23, 2024

(51) Int. Cl. A63F 13/67; A63F 13/69; A63F 13/79

(52) U.S. Cl. CPC A63F 13/67; A63F 13/69; A63F 13/79

(57) ABSTRACT

Systems, processes and device configurations are provided for electronic gaming control and fragmented functionality normalization for electronic games. Users of electronic games may be subject to one or more laws or regulations restricting exchange of data or limiting game technology. Limitations may be based on user preferences for privacy, subject matter depicted, and restrictions on use of technology (e.g., biometric detection, artificial intelligence, etc.). Additional restrictions may be imposed for content ratings, age restrictions, player preferences, and privacy settings. Processes and device configurations described herein allow for game sessions to be provided while determining one or more modifications in response to one or more limitations. Processes include determining fragmented functionality limitations for a game session to identify at least one of game operation for modification and determining a normalization setting for the game session. Normalization settings may modify at least one operation of electronic games during the game session.

### FIELD

The present disclosure is directed to interactive entertainment and electronic video gaming, including gaming device operations, processes, configurations, user interface control and control device configurations.

### BACKGROUND

Gaming systems come in many different configurations and support different game types, including games on computer systems and console games. These different systems may offer players different types of gaming experiences even when hosting similar game titles. Similarly, electronic games played over network communications, such as multiplayer games, may allow users to interact and play electronic games with one or more other users over a network using similar or different gaming configurations. Game titles popular for network gaming include fighting games, first person shooters, third-person shooters, multiplayer online battle, racing, and strategy games. Network electronic games are popular for personal use and for game competitions including Esports-electronic sports competition using games. There may be one or more factors that lead to different gameplay experiences for users, including factors beyond differences in system configurations. There is a desire to improve player experience despite differences in game systems or factors restricting gameplay. Players in different locations may be restricted from one or more game actions. There is also a desire to account for differences of game features and reduce fragmentation of functionality in gameplay. It may be difficult for conventional devices and configurations to detect differences in user experience or fragmented functionality. In addition, existing devices may not be configured to address factors affecting gameplay experience. There is a need and a desire to provide users of electronic games features for adjusting gameplay experiences.

### BRIEF SUMMARY OF THE EMBODIMENTS

Disclosed and described herein are systems, methods and configurations for electronic gaming control and fragmented functionality normalization. In one embodiment, a method includes detecting, by a device, at least one user for a game session of an electronic game, and determining, by the device, at least one fragmented functionality limitation for the game session based on the at least one user, wherein the fragmented functionality limitation is determined to identify at least one of game operation for modification during for the game session. The method also includes determining, by the device, a normalization setting for the game session of the electronic game using the fragmented functionality limitation, wherein the normalization setting modifies the at least one operation of the electronic game during the game session based on the fragmented functionality limitation. The method also includes controlling, by the device, output of the game session with the normalization setting.

In one embodiment, detecting at least one user for the game session includes identifying a location of the at least one user and identification of a least one of a regional limitation and a regulatory limitation for the location.

In one embodiment, determining at least one fragmented functionality limitation for the game session includes using a machine model to detect an electronic game feature that is unavailable for at least one participant of the game session.

In one embodiment, determining at least one fragmented functionality limitation for the game session includes identifying at least one of a regional and regulatory limitation of the electronic game.

In one embodiment, determining at least one fragmented functionality limitation for the game session includes identifying at least one game object and game feature based on a content preference of the at least one user.

In one embodiment, the normalization setting for the game session of an electronic game is determined using the fragmented functionality limitation, and the normalization setting replaces at least one of a game object and game feature.

In one embodiment, the normalization setting for the game session of an electronic game is determined using the fragmented functionality limitation, and the normalization setting generates a new game object based on the fragmented functionality limitation.

In one embodiment, the normalization setting for the game session of an electronic game removes content of the electronic game based on fragmented functionality limitations for a plurality of game session participants.

In one embodiment, controlling output of the game session with the normalization setting includes replacing at least a portion of a game data stream based on the normalization setting.

In one embodiment, controlling output of the game session with the normalization setting includes removing content of the electronic game for game session participants from at least one game data stream.

Another embodiment is directed to a device configured for electronic gaming control and fragmented functionality normalization. The device includes an interface, memory storing executable instructions, and a controller coupled to the interface and memory. The controller is configured to detect at least one user for a game session of an electronic game and determine at least one fragmented functionality limitation for the game session based on the at least one user, wherein the fragmented functionality limitation is determined to identify at least one of game operation for modification during for the game session. The controller is configured to determine a normalization setting for the game session of the electronic game using the fragmented functionality limitation, wherein the normalization setting modifies the at least one operation of the electronic game during the game session based on the fragmented functionality limitation. The controller is configured to control output of the game session with the normalization setting.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 is a graphical representation of electronic gaming control and fragmented functionality normalization according to one or more embodiments;

FIG. 2 illustrates a process for electronic gaming control and fragmented functionality normalization according to one or more embodiments;

FIG. 3 illustrates a graphical representation of a device configuration according to one or more embodiments;

FIG. 4 illustrates a graphical representation of normalization settings according to one or more embodiments;

FIG. 5 illustrates a graphical representation of a machine model for fragmented functionality normalization according to one or more embodiments; and

FIG. 6 illustrates a graphical representation of functionality normalization according to one or more embodiments.

### DETAILED DESCRIPTION OF THE EXEMPLARY EMBODIMENTS

### Overview and Terminology

One aspect of the disclosure is directed to electronic gaming control and functionality normalization. As referred to herein, functionality normalization can include identification of one or more parameters that cause players to have a different experience due to at least one of game function availability and restrictions, and modification of one or more game features or game presentation to adjust, and/or normalize, a user gameplay experience in response to the one or more parameters. Functionality normalization can perform to address one or more factors that restrict a game feature or game functionality for one or more users (e.g., player) of a game session. For example, a feature or functionality may be available to one user in a game session for an electronic game and not be available to a second player due to one or more restrictions. Restrictions on game features may be due to one or more laws or regulations restricting on the use of technology (e.g., restrictions on artificial intelligence), laws or regulations protecting player privacy, laws or regulations on the subject matter depicted in content, content ratings, age restrictions, player preferences, privacy settings, and/or system differences. Conventional games and game systems may not be aware of restrictions and cannot address restrictions. Processes and device configurations may detect one or more factors that limit functionality for a game and game session. In addition, processes and device configurations can modify game features and game functionality for one or more users of a game session to allow for the game session to be presented with one or more modifications performed to comply with restrictions. According to embodiments, processes and device configurations may determine at least one fragmented functionality limitation for the game session based on the at least one user of the game sessions. Devices presenting electronic games may present content and normalization of the game content in view of the restrictions may allow for play between multiple players in a game session or tournament.

According to embodiments, processes and device configurations are provided for network games, such as multiplayer or cloud-based games. Differences in functionality available to one or more users may be determined based on gameplay data from one or more game streams, user profile data, user hardware, user locations, and stored databases for restrictions. Embodiments can determine and modify game output based on one or more known restrictions of game functions or game features, the restrictions based on user location, regional or legal restrictions associated with a user location and one or more user restrictions. User profile data for example, can include user preferences to opt-out of functionality, such as a selection to for content to not use learning models or artificial intelligence for presentation of game data. Normalization may be performed for a player on a console game or a network game. Normalization may be performed for players playing directing from a console, and players in a multiplayer game session wherein normalization may be based on game functions available to one or more or players of a session. Processes and device configurations may also be directed to virtual reality (VR) and augmented reality applications and systems.

According to embodiments, processes and device configurations are provided for electronic gaming control and fragmented functionality normalization. Processes may be performed by one or more of a game server, network device, and interactive entertainment device, such as a game console. Processes and device configurations may be configured to detect at least one user for a game session of an electronic game and determine at least one fragmented functionality limitation for the game session based on detected users. There are many factors that might make a feature or functionality available to a first user, and limit or restrict the feature for a second user. Embodiments can detect fragmented functionality and determine one or more modifications to allow for a game session. Fragmented functionality may be based on one or more of a user location, regulation associated with user location (e.g., legal regulation, privacy restriction, etc.) and one or more user settings. Embodiments provide processes and device configurations that can allow for different features and functionality for different players. Embodiments also provide normalization of play between multiple players in the same gaming session or tournament.

Embodiments are directed to systems, devices and methods for game operations and controls, including operations for gameplay normalization. Embodiments may be performed by gaming systems including one or more of consoles and network devices such as servers (e.g., cloud server, network server, back-end server, etc.). Gaming systems may include consoles that play game media, consoles that provide network data for games, handheld devices, mobile devices (e.g., tablets, mobile phones, etc.) and devices in general configured for electronic gaming.

According to embodiments, a normalization setting may be determined for the at least one user of the electronic game based on one or more restrictions detected, the normalization setting modifying at least one game operation of the electronic game. The process may include controlling output of the game data stream using the normalization setting for the at least one user. Normalization methods may include detecting differences in gameplay restrictions for players and methods for adjusting ways that players experience gameplay.

Processes and device configurations can include detection and processing of game data and identification of restrictions using one more model, such as a machine learning (ML) model, to identify and control normalization of one or more functions and objects of a game title. Normalization may disable a feature for one or more users of a game session, such as limiting or suspending use of eye tracking operations associated with presentation of game content. Other game functions of a game title may similarly be limited including processes for content generation, user customized items and one or more user tracking inputs. Embodiments are directed to training one or more machine models to identify one or more restrictions associated with users and for controlling and/or modifying game presentation based on the restrictions in order to enable game play. Machine models may be configured to normalize one or more operations of a game and game system.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### EXEMPLARY EMBODIMENTS

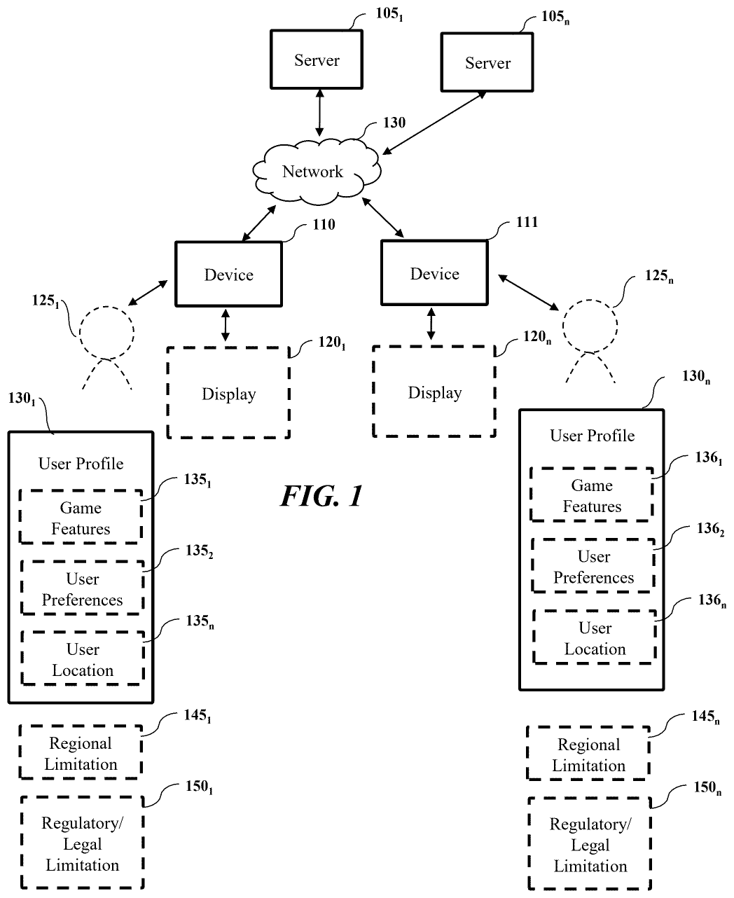

FIG. 1 is a graphical representation of electronic gaming control and fragmented functionality normalization according to one or more embodiments. Electronic gaming control and functional normalization may be performed by one or more devices of system 100. Operations of system 100 may be performed by one or more of servers 105₁₋ₙ and devices, such as device 110 and device 111, for controlling and/or normalization of game streams. Devices 110 and 111 may be a game console and/or an interactive device configured to output game content to a user, such as users 125₁₋ₙ. Devices 110 and 111ₙ may be a game console, entertainment device, display device or media player. According to embodiments, system 100 may include one or more of servers 105₁₋ₙ to service one or more game devices. Servers 105₁₋ₙ may be one or more network devices. Servers 105₁₋ₙ may each be a network device configured to provide game data including game data streams for network or multiplayer games. According to embodiments, at least one of devices 110 and 111, and servers 105₁₋ₙ may be used to output an electronic game for one or more users, such as user 125₁₋ₙ. According to embodiments, system 100 may perform one or more operations on a game stream for electronic gaming control and functional normalization.

According to embodiments, processes and device configurations may be performed for a user, such as user 125₁, to play an electronic game provided by one or more of a device, such as device 110, and a server, such as one or more of servers 105₁₋ₙ. System 100 may allow for hosting one or more multiplayer game sessions for user 125₁ with one or more other users, such as user 125ₙ. Similar to user 125₁, user 125ₙ may receive game stream data for an electronic game provided by one or more of a device (e.g., device 111), and a server (e.g., servers 105₁₋ₙ). Users 125₁₋ₙ may view game stream content from one or more devices such as device 110 and device 111. Users of system 100 may be presented game content on optional displays, such as displays 120₁₋ₙ. According to embodiments, processes and configurations may be configured to normalize the experience of one or more users, such as one more of users 125₁₋ₙ. Normalization may be based on one or more detected parameters including the type and condition of devices of system 100. Devices of system 100 may communicate with servers 105₁₋ₙ by way of network 130. According to embodiments, one or more of servers 105₁₋ₙ and devices 110 and 111 may be configured to store and/or use user profile data of one or more users. User profile data 130₁₋ₙ may relate to user profile data for users 125₁₋ₙ. User profile data may store one or more preferences of a user and characteristics associated with a user. User profile data 130₁ may include data for one or more of game features 130₁, user preferences 1302, and user location 130ₙ. Game features 130₁ may include an identification or configuration of one or more game features available to a user for one or more game titles. Game features may include game characters, game objects, game states (e.g., access) and/or in game functions that may be available for a user. User preferences 1302 may include one or more user indicated preferences for one or more game titles including preferences, user defined settings, content restrictions, and age restricted settings. User location 130ₙ may include one or more of a user location, user region and country associated with a user's location. Similarly, user profile data 130ₙ for user 125ₙ may include data for one or more of game features 1361, user preferences 1362, and user location 136ₙ. According to embodiments, one or more of a device, such as device 110, and a server, such as one or more of servers 105₁₋ₙ may also be configured to store regional limitation 145₁₋ₙ and regulatory limitations 150₁₋ₙ for one or more users. Regional limitations 145₁₋ₙ may include one or more game features available for a region. By way of example a game object, or game feature in general, may include features available to players in a first region and unavailable to players in another region. Regulatory/legal limitations 150₁₋ₙ may include an identification of one or more features that may be restricted for one or more regions. By way of example a game feature, such as eye trackingₙ may be restricted for players in a first region and available to players in another region. When identified as a fragmented functionality, eye tracking may be restricted and/or game data streams may be modified using a normalization setting.

According to embodiments, users 125₁₋ₙ may utilize one or more devices to participate in a gameplay session. By way of example, user 125₁ may interact with and/or operate at least one of device 110 and display 120₁ to participate in a gameplay session. These devices may be configured for presenting game media, such as electronic game content, receiving user controls and providing user control and game data to one or more network devices, such as server 105₁, for one or more game functions. Server 105₁ may be configured to host and provide data for more game services. According to embodiments, a game stream may include data received by and/or provided to a device. During operation of a game, a game data stream may be provided to one or more devices to allow for presentation of game content. System 100 may be configured to control presentation of content associated with an electronic game. System 100 may also be configured for identifying one or more parameters for normalizing game content.

Device 110 may be configured to control and present gaming content for one or more users, such as user 125₁. Device 110 may be a control device, such as a console, configured to operate with one or more peripherals or control devices, such as a game controller (e.g., handheld controller) and optional display 120₁. Game stream data received by devices may include audio and video data for presentation of an electronic game. Device 110 may be configured to receive user controls by way of one or more controllers. According to embodiments, device 110 may output gaming content to display 120₁. Communication with server 105₁ may be over network 130 to provide one or more multiplayer game operations.

According to embodiments, one or more devices of system 100, such as at least one of device 110 and servers 105₁₋ₙ, may control an electronic game for a user and for determining one or more normalization settings for users of the electronic game. Control of the electronic game may be network based, such that one or more operations are directed by control commands of servers 105₁₋ₙ. Device 110 may be local to user 125₁ and may perform one or more operations for normalization and/or to implement control commands received from a server for one or more users. According to embodiments, devices local to a user, such as devices 110 and 111 may be configured to normalize one or more game functions. According to embodiments, one or more components of system 100, such as device 110 and server 105₁ may perform processes relative to one or more game streams. By way of example, device 110 may control presentation of an electronic game on display 120₁ for user 125₁ and device 110 may exchange data with server 105₁ over network 130. Server 105₁ may receive data from one or more other devices, such as devices 110 and 111 for users 125₁₋ₙ. According to embodiments, a game data stream generated for device 110 associated with user 125₁ may include game data for one or more game elements controlled by user 125₁ and one or more game elements associated with other users of the gameplay session, such as user 125ₙ. According to embodiments, system 100 may perform one or more processes including determining a fragmented functionality limitation to identify at least one of game operation for modification during for the game session. Using the fragmented functionality limitation, system 100 can determine a normalization setting for the game session of an electronic game. The normalization setting may be determined to modify the least one operation of the electronic game during the game session based on the fragmented functionality limitation. At least one of game features 1351, user preferences 1352, user location 135ₙ, regional limitation 145₁, and regulatory limitation 150₁ may be used to identify a fragmented functionality for user 125₁. Similarly, for a game session with user 125ₙ, at least one of game features 1361, user preferences 1362, user location 136ₙ, regional limitation 145ₙ, and regulatory limitation 150ₙ may be used to identify a fragmented functionality. System 100 may control output of a game session with the normalization setting. System 100 may update the game data stream to include the at least one normalization setting and output the game stream. By way of example, detection of user 125₁ having a regulatory restriction not allowing a technology (e.g., eye tracking, etc.) may result in system 100 controlling one or more game parameters to avoid or deactivate eye tracking functions for one or more users. Normalization may be based on one or more players of a game session. As discussed herein, normalization settings may modify one or more game functions and objects to adjust the experience for one or more players. According to embodiments, servers 105₁₋ₙ may be network servers, backend servers, game servers, and servers device in general configured to provide multiplayer game data. Servers 105₁₋ₙ may be configured to perform one or more operations with respect to user profiles for a user, such that normalization allows for players with different system functionalities or permissible functions to engage in game sessions. According to other embodiments, normalization may adjust settings based on detected differences in player devices (e.g., hardware, control inputs, etc.). Features of the game session are identified based on elements of the game and

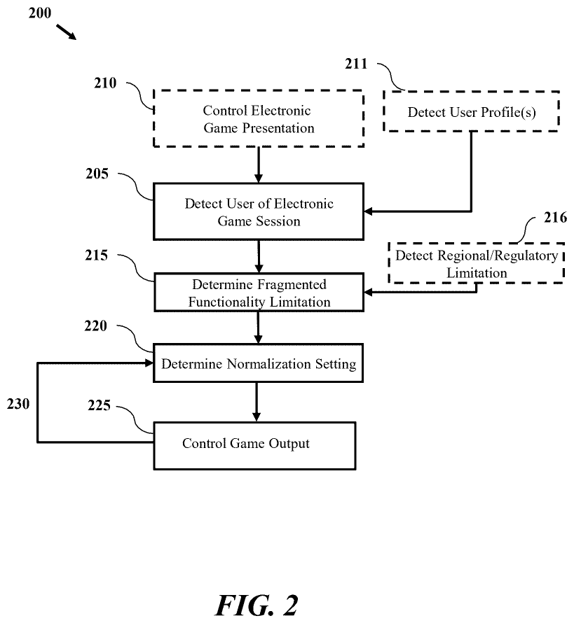

As discussed below in more detail with respect to FIGS. 2, 4 and 5, processes are provided for electronic gaming control and functional normalization relative for one or more users, such as users 125₁₋ₙ and users accessible by way of network 130. System 100 may operate for multiplayer games. According to embodiments, server 105₁ may be configured to provide game data streams to one or more users of a multiplayer game. Server 105₁ and one or more additional servers of system 100 (e.g., server 105ₙ)ₙ may be configured to manage a multiplayer gaming session for one or more devices, such as devices 110 and 111 and one or more devices associated with users 125₁₋ₙ.

According to embodiments, system 100 is configured to allow for control and presentation of electronic gaming content, such as content associated with a multiplayer game. System 100 may also be configured to output gaming content by way of one or more game data streams. According to embodiments, the game data streams may be configured prior to transmission over network 130. According to other embodiments, game data streams generated by a server or hosting device may be modified to normalize gameplay experiences. It should be appreciated that operations and processes for collection of user data, including user profile and user preferencesₙ may be based on expressed consent of a user. Users may be notified of operations and collection of user data. Operations may also require adult confirmation and user agreement for operations to be performed on a console or a device. System 100 may provide features to improve user experience, wherein functions and operations described herein are performed following user consent, with express notice to a user, and/or in alignment with one or more user settings for user privacy. It should be appreciated that embodiments may be applied to interactive entertainment with one or more users. Processes described herein are not limited to gaming content.

According to embodiments, servers 105₁₋ₙ may include a memory and/or database for storing one or more of game data, machine models, user profiles, and device characteristics (e.g., functions, limitations, etc.). Servers 105₁₋ₙ may also provide one or more multiplayer functions, such as providing one or more game streams, player management and hosting of multiplayer games. Operations and game control signals generated by a user, such as users 125₁₋ₙ, may be detected by a controller/interface, received by device 105 and output to one or more devices of system 100 to provide normalization of one or more game functions.

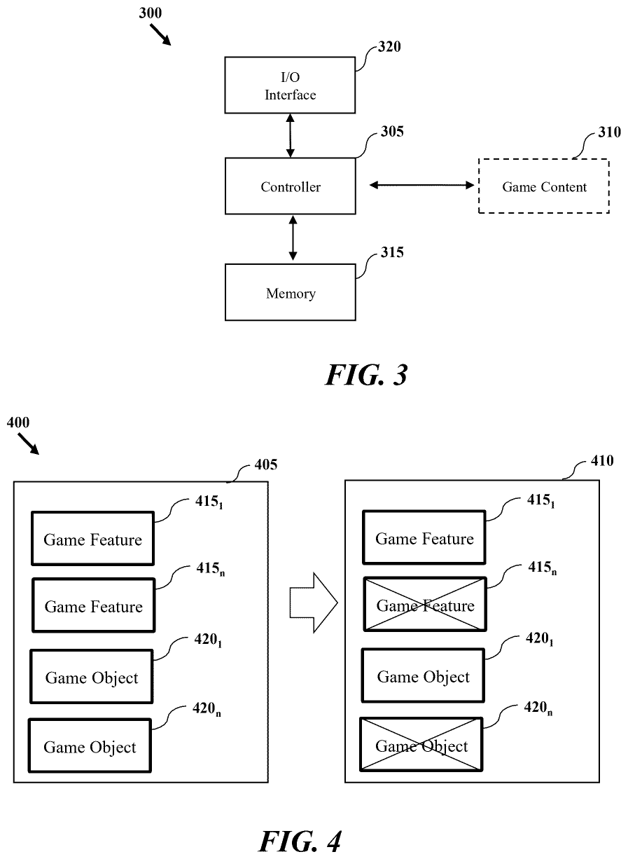

FIG. 2 illustrates a process for electronic gaming control and fragmented functionality normalization according to one or more embodiments. Process 200 may determine one or more normalization settings for an electronic game. In addition, process 200 may track user functionalities and control one or more of game objects, game functions and game settings for one or more of entertainment and control of game play experience. Process 200 may be performed by a device, such as device 110 or server 105₁ of FIG. 1, controller 305 of FIG. 3, or a control device in general.

Process 200 may be initiated by a device detecting at least one user of an electronic game session at block 205. Detecting a user at block 205 can include detecting one or more users of a game session and identifying one or more limitations and/or preferences of users associated with a game title for the users. For example, a first user may be identified as associated with a game session, game title, and game waiting room. Rule sets of players from user profiles and/or based on a user location or region may be identified. By way of example, one or more feature sets for a game title may be identified, user profiles and preferences for a game title and features available to a user. Detecting users at block 205 may be performed by a device when requests for a user to be added to a game session are received, during generation of a new game session and while monitoring a game session. According to embodiments, user profile data may be retrieved by a device to identify one or more profile sets including identification of players to determine location and restrictions. Identification of players may be for game titles using one or more data sets of game content. Detecting at least one user for a game session can include identifying a location of the at least one user. Location of user may include a physical location, such as an address and/or one or more location identifiers, such as region, country/nation, and registered locations. Detecting at least one user for a game session can include identifying a least one of a regional limitation and a regulatory limitation for the location. Locations of a user may be subject to one or more levels of regulation, such as state and federal. Accordingly, there may be more than one source of restrictions for a user. According to embodiments, devices may be configured to identify one or more regulations for a user based on the user's location and one or more databases of regulations for locations. Restrictions identified for a user may be stored by a network and/or associated with a user profile. Users may be detected for a game session when a request for a user to be added to a session is received by a device controlling game operation, including when a new game session is generated and/or during presentation of a game session.

According to embodiments, process 200 may be performed as part of and/or in addition to one or more processes for providing a gameplay session for multiple players. At block 211, process 200 may optionally include detection of one or more user profiles. User profiles may be detected for each user of a game session. According to embodiments, detection of user profiles may allow for identifying one or more fragmented functionalities for a game session.

At block 215, process 200 includes determining at least one fragmented functionality limitation for the game session based on the at least one user detected for a game session. The fragmented functionality limitation may be determined to identify at least one of game operation for modification during for the game session. According to embodiments, determining at least one fragmented functionality limitation for the game session includes using a machine model to detect an electronic game feature that is unavailable for at least one participant of the game session. The machine model may detect one or more game features and use one or more detected restrictions to identify features that require modification. Determining at least one fragmented functionality limitation for the game session includes identifying at least one of a regional and regulatory limitation of the electronic game. According to embodiments, process 200 may optionally include detecting regional/regulatory limitations at block 216. Regional/regulatory restrictions detected at block 216 may be based on one or more of a user's location, user profile data and game stream data.

At block 215, determining at least one fragmented functionality limitation for the game session can include identifying at least one game object and game feature based on a content preference of the at least one user. Users may specify one or more features to restrict from a game session. By way of example, a user may indicate that features for measuring a user are to not be used, such as user imaging. Determining a fragmented functionality limitation may include identifying rule sets for of one or more players. The rule sets may include feature sets, profiles and a set or features available to a user of a game. Determination of fragmented functionality can perform in response to one or more users joining a game session.

According to embodiments, determining a fragmented functionality limitation can include detecting one or more features not available or permissible to a user. Game feature limitations may identify one or more game objects and/or game settings that are restricted. According to embodiments, analysis of fragmented functionality includes use of a machine learning model (e.g., use artificial intelligence (AI) analysis) with game objects, game functions and player indicated restrictions as input. The machine learning model may receive various information as input including video and audio renderings presented to a player, inputs from a controller used by the player, a microphone capturing the player, a camera showing the player, eye tracking data of the player, a chat corresponding to the game play, biometric information from the player, network performance information, game state information from the game title, information from the game system software, and/or information corresponding to other players playing the game. Normalization settings may be determined using one or more identified restrictions and to allow for a game to operate while accounting for one or more restrictions.

At block 220, process 200 includes determining a normalization setting for the game session of an electronic game using the fragmented functionality limitation. The normalization setting can modify the at least one operation of the electronic game during the game session based on the fragmented functionality limitation. According to embodiments, the normalization setting is determined to replace at least one of a game object and game feature of a game title. Normalization can include modification of features visible to a user and modification of game functions and features that are not visible to a user. Normalization settings for the game session may be determined to include generating a new game object based on the fragmented functionality limitation. The normalization setting for the game session of an electronic game can remove content of the electronic game based on fragmented functionality limitations for a plurality of game session participants.

Normalization settings of process 200 may include controlling one or more game data streams output to users. Game data streams can include one or more of graphics, code to direct graphics, user controls, network timing and code describing game functions to present a game. According to embodiments, a control device may receive a game stream for each user of an electronic game. Receiving a game stream may include receiving uplink signals from one or more user devices and detecting one or more downlink communications transmitted to one or more users.

According to embodiments, a normalization setting determined at block 220 may be determined to allow for one or more game functionalities, such as creation and customization of game content for all users while ensuring compliance with one or more limitations. Process 200 may implement one or more normalization settings by detecting game metadata to support content filtering and content modification.

According to embodiments, a normalization setting determined at block 220 may be determined to smooth a skew in game functionalities. A game object may be presented or output to users with different graphical elements or functionalities, wherein the normalization may skew to the lowest common denominator of game functionalities. By way of example, process 200 may limit the fragmentation of functions when possible, to suit all users. Impact of the normalization may be monitored. According to embodiments, machine models may monitor the impact of gameplay for a game session based on one or more determined normalization settings. According to embodiments, game functionalities for players may be identified and monitored as clusters by machine models. For example, game functionalities of each player may be arranged as clusters, with like and unlike features clustered for each user and operations of process 200 may be configured to decrease congestion and players impacted by normalization settings. Identification of feature limitations may be used to adjust one or more game functionalities and skew game functionalities to account for users. Features excluded from clusters may include one or more of us of artificial intelligence, privacy information, use of eye tracking and sensitive information. According to embodiments, a normalization setting determined at block 220 may skew game functionalities of one or more game objects presented and/or output to users to provide one or more skill levels. For example, normalization of skew of game functionalities may include augmenting difficulty levels by way of additional challenges, tasks, enemies, obstacles, etc. By way of further example, some users may have access to objects or features that other users do not have access to. As a result, users with certain features may have to perform a game feature or object with an increased difficulty level. Similarly, normalization may skew game operations to delay reaction time for users and/or increase reaction time for other users within a game session with different skill levels. Skew operations may be aided by chipsets and processors configured for processing multiple game streams or threads (e.g., NVIDIA GB200, AMD XDNA, etc.).

At block 225, process 200 includes controlling output of the game session with the normalization setting. Controlling output of the game session with the normalization setting can include replacing at least a portion of a game data stream based on the normalization setting.

According to embodiments, controlling output of the game session with the normalization setting includes removing content of the electronic game for game session participants.

Process 200 may include feedback operation 230 allowing for process 200 to update, modify or terminate one or more normalization settings for a game session. According to embodiments, feedback 230 may be performed by process 200 to correct game modifications. Feedback 230 may be performed by one or machine models to assess effects of normalization settings on game play sessions. For normalization settings impeding game play, one or more normalization settings may be determined and updated at block 220.

When performed by a network device, such as server 105₁, process 200 may include one or more servers generating and receiving game stream data including gameplay data received from one or more user devices, such as game consoles or media players. The server device may be configured to process game streams from users to determine one or more game actions and data to broadcast to users of a multiplayer game. When performed by a control device local to a user, or associated with a user, the game data stream may include one or more components for presentation of a game. Control devices and consoles may include media or game data local to presentation of a game, the game media configured to receive one or more game data streams to allow for multiplayer gameplay. Process 200 is described below as being performed by a device. According to embodiments, process 200 may be performed by one or more of control devices, consoles, and network devices such as servers of a system (e.g., system 100).

At block 225, process 200 includes controlling game output. Output of game data streams may be controlled using one or more normalization settings for the at least one user. According to embodiments, process 200 and detection and use of normalization settings as described herein allow for normalization across a plurality of dimensions and based on other players in a game session. Normalization may be performed for a period of time, such as during a game session. Process 200 and embodiments allow for leveling one or more game features to control game experience.

FIG. 3 illustrates a graphical representation of a device configuration according to one or more embodiments. Device 300 is configured for detecting fragmented functionality for an electronic game and normalization. Device 300 represents one or more components and functions of server 105₁ and/or device 110. Device 300 may represent one or more of a gaming console, computing device, and electronic device in general configured to output one or more of video, audio, and game data to an output device. Device 300 may provide one or more components of a server or network device.

Device 300 may be a control device or game console device which can include controller 305, memory 315 and input/output (I/O) interface 320. Device 300 may also optionally include game content 310. Device 300 may optionally include and/or communicate with at least one of optional display 325 and optional wearable device/game control input 330. Controller 305 may relate to a processor or control device configured to execute one or more operations stored in memory 315, such as processes for detecting users and fragmented functionality associated with detected users. Memory 315 may be non-transitory memory configured to provide data storage and working memory operations for device 300. Memory 315 may be configured to store computer readable instructions for execution by controller 305 for one or more processes described herein.

Device 300 may be configured to receive gaming media (e.g., card, cartridge, disk, download, etc.) and output visual and audio content of the gaming media to an output device, such as a display. Device 300 may be configured to provide voice communication features for users of a game, such as a game chat. Control device 305 may be configured to receive game data streams by way of I/O interface 320. Controller 305 may also be configured for tracking user performance and normalization of one or more features of the game data stream. Controller 305 may be configured to store a user profile and/or update a user profile stored on a network.

Controller 305 may be configured to receive data from one or more other devices such as other console devices and servers (e.g., server 105ₙ) to present and output game content. For network games, controller 305 may receive game data from a network source, such as a server, by way of a network. Controller 305 may be configured to receive input from one or more peripheral devices. According to embodiments, controller 305 may be a controller for an immersive system, such as at least one of an augmented reality and virtual reality system. As such, controller 305 may be configured to control content for display, detect user reactions and control modification of one or more content streams.

FIG. 4 illustrates a graphical representation of normalization settings according to one or more embodiments. According to embodiments, control of a gameplay session and/or electronic game can include providing graphical and/or audio content to a user from one or more sources including game media, a user control device (e.g., gaming console, media player, etc.) and a network device. According to embodiments, process 400 may control presentation of an electronic game content 405 based on one or more received game data streams. FIG. 4 illustrates normalization according to one or more embodiments, wherein one or more game features and game objects may be restricted.

Process 400 illustrates game functionalities 405 for a game title including a plurality of game features 415₁₋ₙ and game objects 420₁₋ₙ. Game functionalities 405 may include elements of a game title and functions or input sources available to a game. Game features 415₁₋ₙ may include one or more functions that may be provided for a game. Game functions may include input sources or types used by a device to present a game. By way of example, eye tracking data detected by one or more of a game console or device in general may be an input to a game feature for providing feedback and/or game control for a user. Game features 415₁₋ₙ may include use of machine models (e.g., artificial intelligence) to detect one or more sources of user data. Game objects 420₁₋ₙ may include one or more of characters, game landscapes, game objects, and elements displayed an/or used in a game. Game objects may include elements such as fighting tools or characters that have an age rating. Alternatively, game objects or presentation formats may include an age level associated with the use of graphical treatment (e.g., level or detail shown, amount of gore shown, etc.).

According to embodiments, one or more normalization settings may be determined for a game session such that one or more of game features 415₁₋ₙ and game objects 420₁₋ₙ may be modified or restricted. Process 400 illustrates modification of game functionalities 405 to game functionalities 410. Modification of game functionalities may be based on one or more normalization settings for game features 415₁₋ₙ and game objects 420₁₋ₙ. Game functionalities 410 includes game feature 415₁ and game object 420₁. Based on modification using a normalization setting, FIG. 4 illustrates game functionalities 410 with modified or restricted game feature 415₁ and game object 420ₙ. Modification of a game feature may include controlling output of game content to replace the game object. With respect to a user preference or setting such as an age restriction of content or preference to reduce or remove types of content, modification may remove and/or modify graphic content. Similar modifications may be performed for regulatory or regional restrictions. Modification of a game feature may be a limitation of the feature to prevent the game object from being used in a game session. In a similar fashion, modification of game features may include limiting and/or replacing use of functions for a game title during a game session. Game features that detect user characteristics, such as eye tracking and/or bio sensors may be limited due to one or more of a legal, regulatory and user preference. According to embodiments, at least one first normalization setting may be determined for game features 415₁₋ₙ and at least a second normalization may be determined for game objects 420₁₋ₙ. By using one or more normalization settings, different features and functionality may be provided to different players. In addition, gameplay sessions may be normalized for multiple players in the same gaming session or tournament, wherein all users have access to the same or similar game functionalities. Process 400 and processes described herein also allow for content to be created that is acceptable to all users.

Based on a received game stream or a plurality of received game data streams, output of game content can include game video objects such as game object 420₁. Game object 420₁ may be a resource, other character, or other player-controlled character. According to embodiments, based on user performance monitored by a device, at least one normalization setting may be determined for the user. By way of example, normalization may include modifying one or more of game play functions and gameplay operations. Process 400 may include modifying game content and/or operations associated with game object 420₁. Game object 420₁ may be presented with a modified skin, modified graphical treatment, and/or modified function. For example, a user may be participating in a game session with an age restriction may reduce the weapon size or modify the weapon appearance in one or more user game streams and game object 420ₙ may be presented the modification to normalize the gameplay experience for a user. According to embodiments, game content 410 may be presented based on a normalization to include game object 425₁ controlled using handheld controls for example, as opposed to use eye tracking data. The modification may limit one or more control input types, including voice control of a game object or removal of one or more biometric sensors used for controlling game object 420₁. It should be appreciated that normalization according to embodiments is not limited to limiting control input types for a game function or game object.

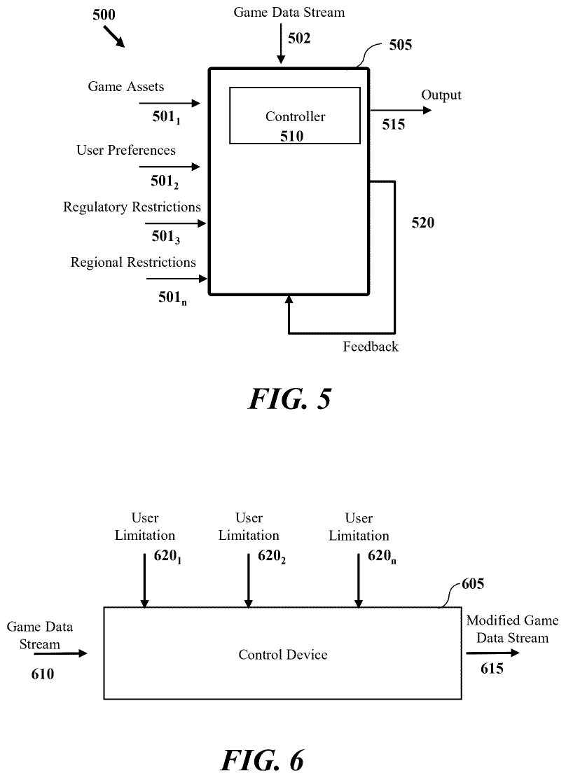

FIG. 5 illustrates a graphical representation of a machine model for fragmented functionality normalization according to one or more embodiments. Process 500 may be performed to determine one or more normalization settings for an electronic game. Once a normalization setting is determined, game functions and features may be modified for one or more users of a gameplay session.

FIG. 5 illustrates training process 500 which can include receiving training parameters 501₁₋ₙ as training input by a device 505 including a controller 510. According to embodiments, controller 510 may receive a plurality of forms of gameplay data by way of game data stream 502, game title data (e.g., game assets), user data and restriction data as training input. In embodiments, training parameters 501₁₋ₙ may include game assets 501₁, user preferences 501₂, regulatory restrictions 501₃, and regional restrictions 501ₙ. Based on training in process 500, controller 510 may generate output 515. Output 515 may include one or more game control parameters for control and/or presentation of game content. According to embodiments, controller 510 may be configured to generate output 515 based on a recursive loop including training and feedback. Feedback loop 520 may provide information such as ratings and accuracy for output 515.

According to embodiments, training process 500 and controller 510 may be configured to use one or more learning models (e.g., artificial intelligence, iterative models, etc.) to modify game data streams. Training process 500 and controller 510 may use one or more libraries of user actions, and device configurations. According to embodiments, output 515 may include output of game content modified based on one or more of game title features and determined restrictions for a user.

Training process 500 may be used to identify and/or modify game features based on one or more fragmented functionality limitations, such as one or more of user preferences 501₂, regulatory restrictions 501₃, and regional restrictions 501ₙ. Process 500 may also be used for determining one or more normalization settings for a game title to modify output of the game title based on the fragmented functionality determined. Process 500 may also determine whether output of the game title with the normalization setting allows for gameplay to be output based on the normalization setting.

According to embodiments, training process 500 performs training to identify one or more parameters of a game title for modification. Training process 500 may generate a machine model configured to receive game data streams, determine fragmented functionalities, and to determine one or more normalization settings. Based on one or more of game assets 501₁, user preferences 501₂, regulatory restrictions 501₃, and regional restrictions 501ₙ, user operations and control may be analyzed to remove or modify game content. In addition to removal or elements, the machine model may determine one or more operations for control of game data streams for at least one of adjusting game output for generating content to replace elements of a game title.

FIG. 6 illustrates a graphical representation of performance normalization according to one or more embodiments. According to embodiments, control device 605 may be configured to receive a game data stream 610 for an electronic game and to generate at least one modified game data stream 615. Control device 605 may perform and/or use one or more operations of training process 500. Modified game data stream 615 may be output by control device 605 to output modified game content using one or more normalization settings. Game data stream 610 may include one or more network streams of game data including control instructions for presentation of game content. In some embodiments, game data stream 610 may include content for presentation of a game. According to other embodiments, game data stream 610 may include one or more data segments including control parameters that may be used by a device, such as a console or wearable device, to present game content. According to embodiments, control device 605 may be configured to receive input parameters for a plurality of users which may be used to normalize game data stream 610.

According to embodiments, at least one fragmented functionality of a game title may be determined based on one or more user limitations 620₁₋ₙ. For a multiplayer game or interactive electronic presentation, control device may include game stream data for a plurality of users. Control device may also receive one or more limitations for a plurality of users. User limitations 620₁₋ₙ may include one or more fragmented functionality restrictions for one or more of a regional limitation, regulatory limitation, and user preference. By way of example, user limitation 620₁ may include one or more limitations for a first user, and user limitation 620₂ may include one or more limitations for a second user. According to embodiments, normalization settings may be determined to account for one or more fragmented functionality limitations identified by user limitations 620₁₋ₙ.

During a gameplay session a first user and a second user may have different features of a game title available due to one or more fragmented functionality limitations. Normalizing game data streams to account for all player differences in a single stream may be difficult. However, certain modifications may be made to one or more players game data streams or data that is provided to the users. For example, modified game data steam 615 can include dedicated game streams for each user. Normalization can include modification of game functions to modify one or more features for each user output stream. Control device 605 may be a controller for a network device providing game stream data for one or more users including output of modified game data stream 615 which may include content for augmented reality and virtual reality applications.

While this disclosure has been particularly shown and described with references to exemplary embodiments thereof, it will be understood by those skilled in the art that various changes in form and details may be made therein without departing from the scope of the claimed embodiments.

What is claimed is:

1. A method for electronic gaming control and fragmented functionality normalization, the method comprising:
detecting, by a device, at least one user for a game session of an electronic game;
determining, by the device, at least one fragmented functionality limitation for the game session based on the at least one user, wherein the fragmented functionality limitation is determined to identify at least one of game operation for modification during for the game session;
determining, by the device, a normalization setting for the game session of the electronic game using the fragmented functionality limitation, wherein the normalization setting modifies the at least one operation of the electronic game during the game session based on the fragmented functionality limitation; and
controlling, by the device, output of the game session with the normalization setting.

2. The method of claim 1, wherein detecting at least one user for the game session includes identifying a location of the at least one user and identification of a least one of a regional limitation and a regulatory limitation for the location.

3. The method of claim 1, wherein determining at least one fragmented functionality limitation for the game session includes using a machine model to detect an electronic game feature that is unavailable for at least one participant of the game session.

4. The method of claim 1, wherein determining at least one fragmented functionality limitation for the game session includes identifying at least one of a regional and regulatory limitation of the electronic game.

5. The method of claim 1, wherein determining at least one fragmented functionality limitation for the game session includes identifying at least one game object and game feature based on a content preference of the at least one user.

6. The method of claim 1, wherein the normalization setting for the game session of an electronic game is determined using the fragmented functionality limitation, and the normalization setting replaces at least one of a game object and game feature.

7. The method of claim 1, wherein the normalization setting for the game session of an electronic game is determined using the fragmented functionality limitation, and the normalization setting generates a new game object based on the fragmented functionality limitation.

8. The method of claim 1, wherein the normalization setting for the game session of an electronic game removes content of the electronic game based on fragmented functionality limitations for a plurality of game session participants.

9. The method of claim 1, wherein controlling output of the game session with the normalization setting includes replacing at least a portion of a game data stream based on the normalization setting.

10. The method of claim 1, wherein controlling output of the game session with the normalization setting includes removing content of the electronic game for game session participants from at least one game data stream.

11. A device configured for electronic gaming control and fragmented functionality normalization, the device comprising:
an communication interface;
a memory storing executable instructions; and
a controller coupled to the communication interface and the memory, wherein the controller is configured to
detect at least one user for a game session of an electronic game;
determine at least one fragmented functionality limitation for the game session based on the at least one user, wherein the fragmented functionality limitation is determined to identify at least one of game operation for modification during for the game session;
determine a normalization setting for the game session of the electronic game using the fragmented functionality limitation, wherein the normalization setting modifies the at least one operation of the electronic game during the game session based on the fragmented functionality limitation; and
control output of the game session with the normalization setting.

12. The device of claim 11, wherein detecting at least one user for the game session includes identifying a location of the at least one user and identification of a least one of a regional limitation and a regulatory limitation for the location.

13. The device of claim 11, wherein determining at least one fragmented functionality limitation for the game session includes using a machine model to detect an electronic game feature that is unavailable for at least one participant of the game session.

14. The device of claim 11, wherein determining at least one fragmented functionality limitation for the game session includes identifying at least one of a regional and regulatory limitation of the electronic game.

15. The device of claim 11, wherein determining at least one fragmented functionality limitation for the game session includes identifying at least one game object and game feature based on a content preference of the at least one user.

16. The device of claim 11, wherein the normalization setting for the game session of an electronic game is determined using the fragmented functionality limitation, and the normalization setting replaces at least one of a game object and game feature.

17. The device of claim 11, wherein the normalization setting for the game session of an electronic game is determined using the fragmented functionality limitation, and the normalization setting generates a new game object based on the fragmented functionality limitation.

18. The device of claim 11, wherein the normalization setting for the game session of an electronic game removes content of the electronic game based on fragmented functionality limitations for a plurality of game session participants.

19. The device of claim 11, wherein controlling output of the game session with the normalization setting includes replacing at least a portion of a game data stream based on the normalization setting.

20. The device of claim 11, wherein controlling output of the game session with the normalization setting includes removing content of the electronic game for game session participants from at least one game data stream.
